(19) United States
(12) Patent Application Publication
(10) Pub. No.: US 2023/0105194 A1
(43) Pub. Date: Apr. 6, 2023

(54) FLAT PANEL FASTENER DEVICES USING MAGNESIVE REVERSE POLARITY

(71) Applicant: Shweta Harve, Parker, TX (US)

(72) Inventor: Shweta Harve, Parker, TX (US)

(21) Appl. No.: 17/955,906

(22) Filed: Sep. 29, 2022

Related U.S. Application Data
(60) Provisional application No. 63/253,065, filed on Oct. 6, 2021.

(51) Int. Cl. F16B 12/00

(52) U.S. Cl. CPC F16B 12/00; F16B 2001/0035

(57) ABSTRACT

A system for fastening panels in a perpendicular manner is provided. The system comprises a semicircular base frame attached in a recessed manner into an edge area of a first panel, a similarly shaped semicircular top frame fastened atop the base frame, and a dial magnet assembly resident in the top frame. The system also comprises a slider mount assembly with an embedded magnet and attached proximate an edge of a second panel that receives insertion into a cavity created by the fastening of the top frame to the base frame. The slider mount assembly also receives attraction to the top frame based on a turning action of the dial magnet assembly in a first direction and binds to the fastened top frame and base frame based on the received attraction. The binding of the slider mount assembly to the fastened frames binds the two panels in a perpendicular manner.

### CROSS REFERENCE TO RELATED APPLICATIONS

The present non-provisional patent application is related to U.S. Provisional Patent Application No. 63/253,065 filed Oct. 6, 2021, the contents of which are incorporated herein in their entirety.

### FIELD OF THE DISCLOSURE

The present disclosure is in the field of furniture construction. More particularly, the present disclosure provides systems and methods of joining flat panels using magnets in panels wherein reverse polarity of magnets is used to attract and firmly bind such panels.

### BACKGROUND

Binding wooden or other panels together for manufacturers, furniture builders, carpenters, furniture repair professionals, and others is is a challenging task. Traditionally screws are used which leave permanent holes and are time consuming and error prone to install as well as remove. Connector sleeves are also used.

Other techniques and materials use to join furniture and other panels include wood glue with the help of clamps, metal straps, dowel joint, kreg jig, tabled lamp joint, half lamp joint, bevel cut scarf joint, and stepped scarf joint. Most of these techniques are time consuming, require considerable expertise, and call for specialized equipment and tools.

### BRIEF DESCRIPTION OF THE FIGURES

FIG. 1 through FIG. 30 are diagrams of systems of flat panel fastener devices using magnesive reverse polarity according to embodiments of the present disclosure.

FIG. 31 through FIG. 35 are tables providing information about the systems provided herein according to embodiments of the present disclosure.

### DETAILED DESCRIPTION

Systems and methods described herein provide several structures for perpendicularly attaching panels in primarily furniture applications. Each structure involves two devices, one device on each of the two panels to be bound. Rotatable, dial-like diametric magnets are key components in each structure such that by turning a magnet either clockwise or counterclockwise, polarity may be changed, and the two subject panels may be magnetically bound or unbound.

Diametric magnets are magnetized across their diameters. A north pole is on one curved side. A south pole is on the opposite curved side. The magnet in a first device attached to a first panel may be turned to engage with a stationary magnet in a second device attached to a second panel. The magnetic attraction created by the rotation of the magnet in the first device secures the two devices and therefore panels tightly in the installed position. The panels are bound to each other based on attraction of magnets in the devices on each panel.

The rotatable magnet may be turned in the opposite direction to change the polarity and disengage the devices, allowing connected panels to be separated. The turning in the opposite direction converts the attraction to repulsion such that the two devices and their corresponding panels are no longer bound.

Three fastener systems are provided herein and are referred to hereafter for brevity by their commercial names as the Slide It™, Glide It™, and Hold It™. The Slide It™and Glide It™ involve two panels attached perpendicularly at their edges with a first device on one panel inserting into a second device on a second panel. The first device has a magnet that dials and either attracts or repels with a stationary second magnet embedded in a second device attached to a second panel. The second device is partially embedded into the body of the second panel.

The Hold It™ differs from the Slide It™ and Glide It™ as it does not involve two panels attaching at edges. Instead, the Hold It™ is more suited to affixing shelves in a bookshelf or cupboard. While still attaching perpendicularly, the horizontal shelf is attached to a vertical interior wall of a bookshelf or cupboard, and not at an edge.

With the Hold It™, a first device containing an embedded magnet it attached to an underside of an end of a shelf. A second device with a rotatable magnet is attached to the vertical interior surface of the bookshelf or cupboard wall. The horizontal shelf with embedded first device on the shelf's underside is laid atop the second device. A dial on the rotatable magnet in the second device is turned, action that results in the rotatable magnet attracting to the embedded magnet in the first device. The shelf is held down onto the second device and is effectively bound to the interior wall of the bookshelf or cupboard.

These three structures rely on rotation of diametric magnets that change polarity. Each of the Slide It™, the Glide It™ and the Hold It™ involves a rotatable magnet in one device on one panel being turned such that polarity changes and either attraction or repulsion occurs with a second magnet on a second panel.

In some embodiments polymagnets may be used. Polymagnets are smart magnets where a conventional axial magnet can be reprogrammed to change polarity at desired rotational degrees. The rotation degree to reverse polarity can be flexible if polymagnets are used. Diametric magnets may only be rotated at 180°.

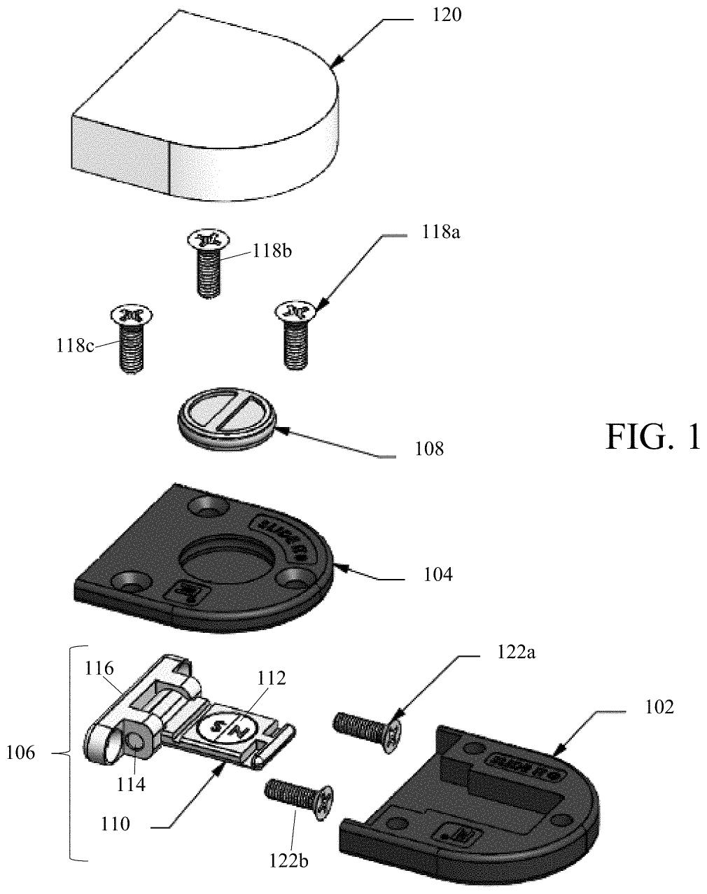

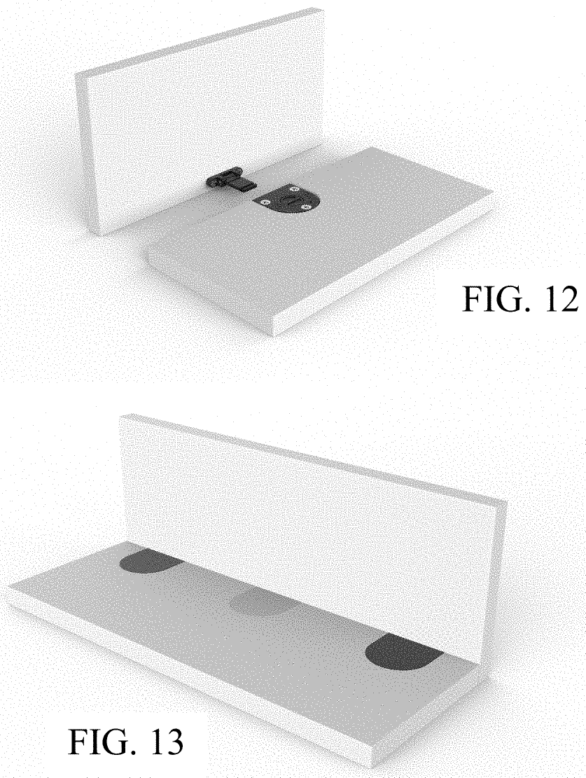

Turning to the figures, FIG. 1 is a diagram of a system of a flat panel fastener device using magnesive reverse polarity according to an embodiment of the present disclosure. FIG. 1 depicts components of a system 100 of the Slide It as the configuration may be referred to commercially. Components and interactions of the Slide It are depicted in FIG. 1 through FIG. 13.

The system 100 comprises a base frame 102, a top frame 104, a slider mount assembly 106, and a dial magnet assembly 108. The slider mount assembly 106 represents a combination of four subcomponents: an insert 110, an embedded magnet 112, a pin 114, and a bracket 116. References to the slider mount assembly 106 refer to the four subcomponents acting in combination.

The system 100 also comprises base frame mount screws 118a-c, a cover 120, and wood mount screws 122a-b. Not shown in FIG. 1 are a first panel to which the base frame 102 is attached and a second panel to which the slider mount assembly 106 is attached.

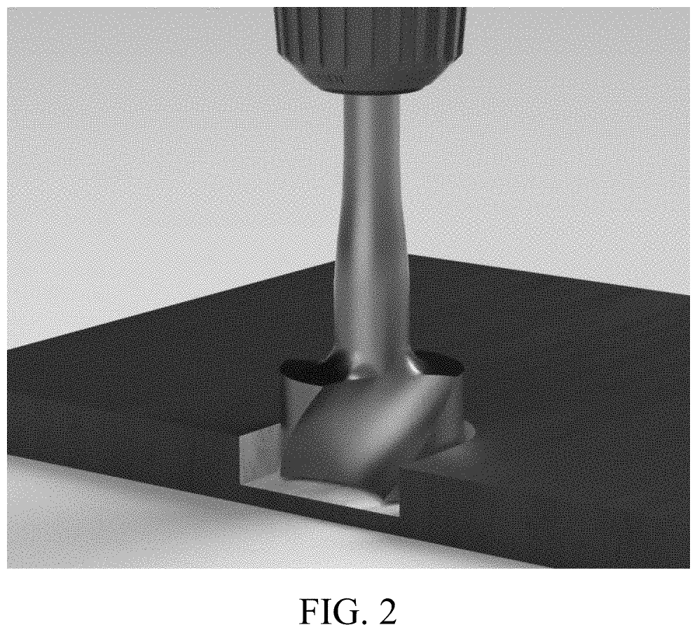

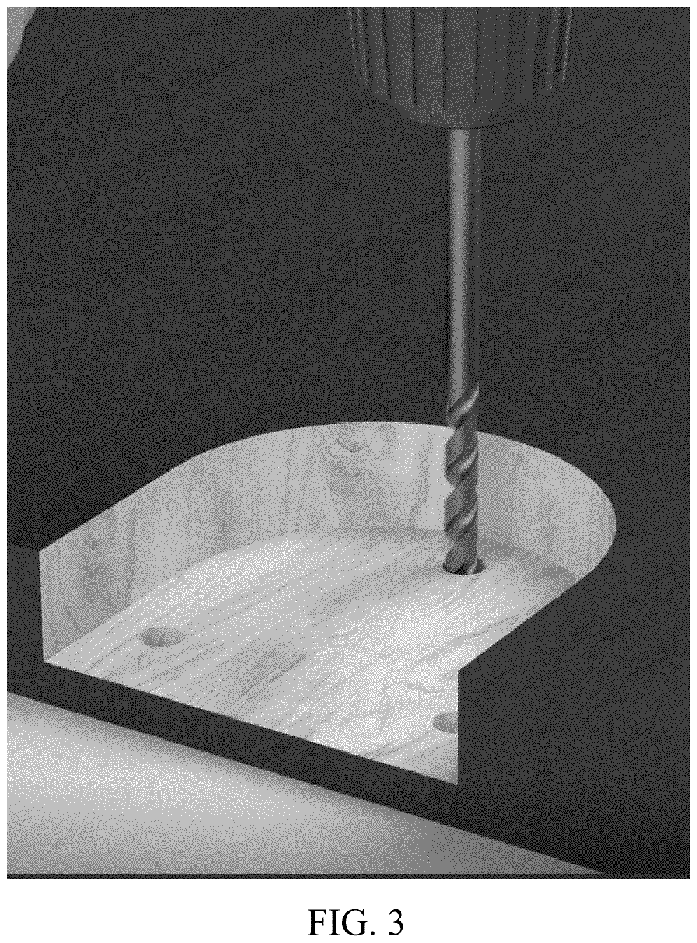

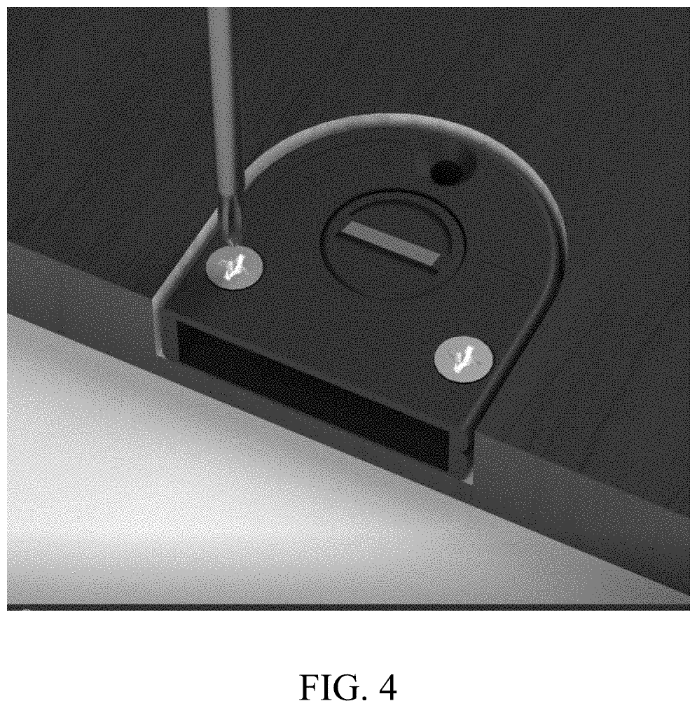

The base frame 102 is embedded into the first panel by creation of a semicircular indentation in the first panel using an electric or manual drilling tool with a specialized bit. This is illustrated in FIG. 2. Three pilot holes are then bored into the floor surface of the indentation. This action is illustrated in FIG. 3. The base frame 102 is placed into the indentation and the top frame 104 is positioned atop the base frame 102. The three base frame mount screws 118a-c are used to screw the top frame 104 onto the base frame 102 and into the three pilot holes. This action is shown in FIG. 4.

The action described above binds the top frame 104 to the base frame 102 to effectively create a single component with a cavity inside. This also includes the dial magnet assembly 108 which is set into a recessed area at the top surface of the top frame 104 which is flush with the surface of the first panel. Also, a slot or open area is present at the edge of the combined frames facing outward which provides an opening for insertion of the slider mount assembly 106 into the cavity as described below.

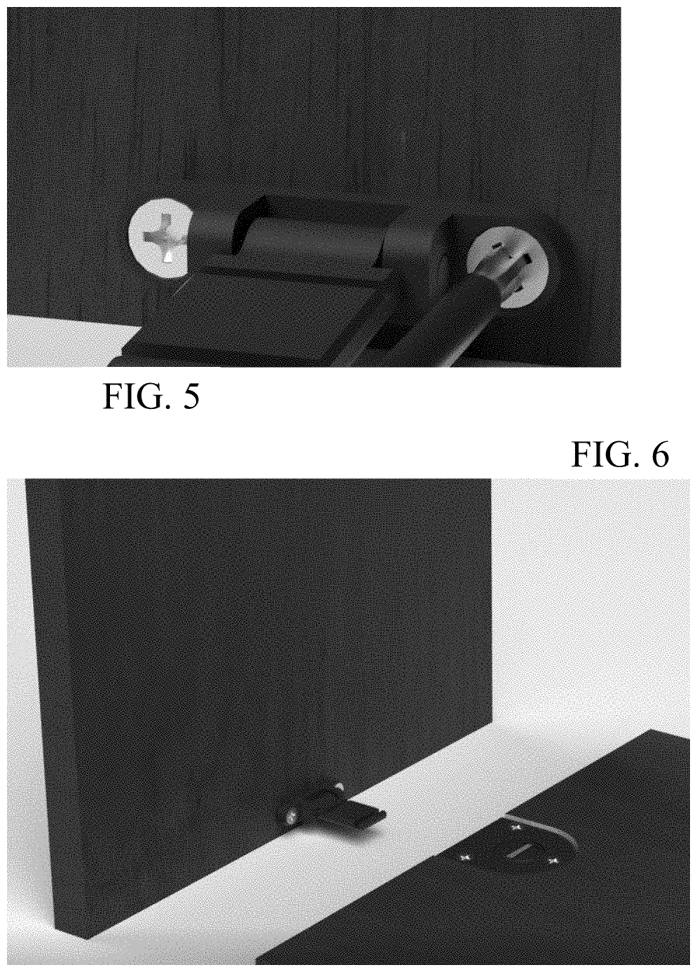

As noted above, the slider mount assembly 106 of the system 100 represents a combination of four subcomponents: an insert 110, an embedded magnet 112, a pin 114, and a bracket 116. The embedded magnet 112 is set inside the insert 110. The insert is attached to the bracket 116 via the pin 114 which allows the slider mount assembly 106 to swivel in up and down directions, easing insertion of the insert 110 into the cavity area. The bracket 116 attaches to the second panel via the wood mount screws 122a-b as shown in FIG. 5.

As shown in FIG. 6, the slider mount assembly 106 protrudes outward from an edge area of the second panel. The slider mount assembly 106 protrudes toward the first panel and the cavity area of the combined top frame 104 and base frame 102 into which the slider mount assembly 106 will be inserted to bind the first and second panels.

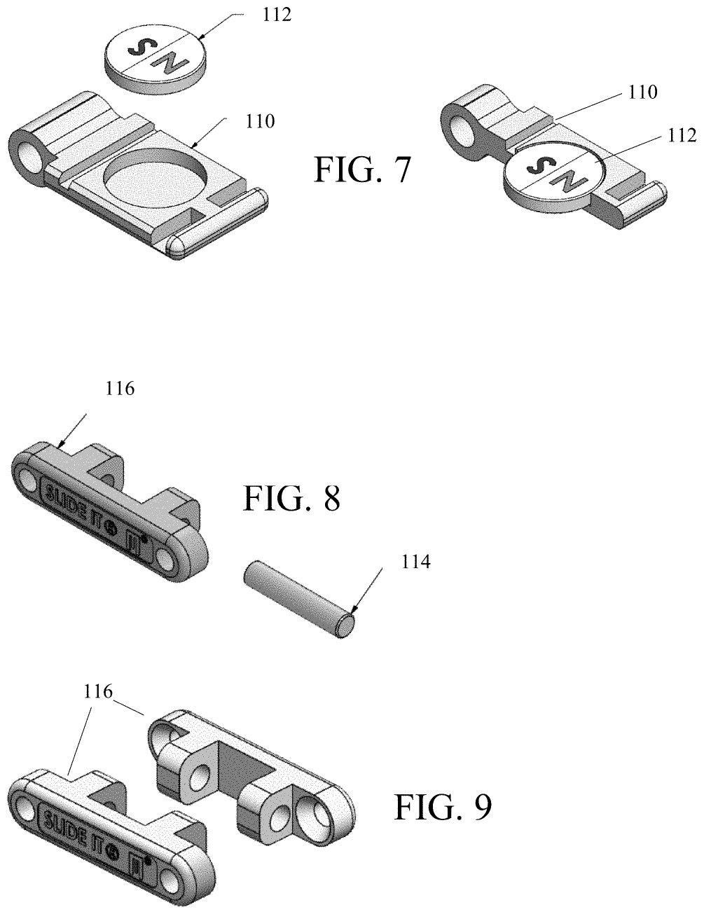

FIG. 7 depicts two different views of the insert 110 and the embedded magnet 112. The righthand view is a cutaway view of the insert 110 and the embedded magnet 112. FIG. 8 depicts the pin 114 and the bracket 116 and FIG. 9 depicts a front view and a rear view of the bracket 116.

Once the insert 110 with embedded magnet 112 are inserted into the cavity of the combined top frame 104 and base frame 102, the dial magnet assembly 108 may be turned. This action changes polarity and results in attraction of the dial magnet assembly 108 to the embedded magnet 112 with further results of the slider mount assembly 106 binding to the combined top frame 104 and base frame 102 and the first panel binding to the second panel.

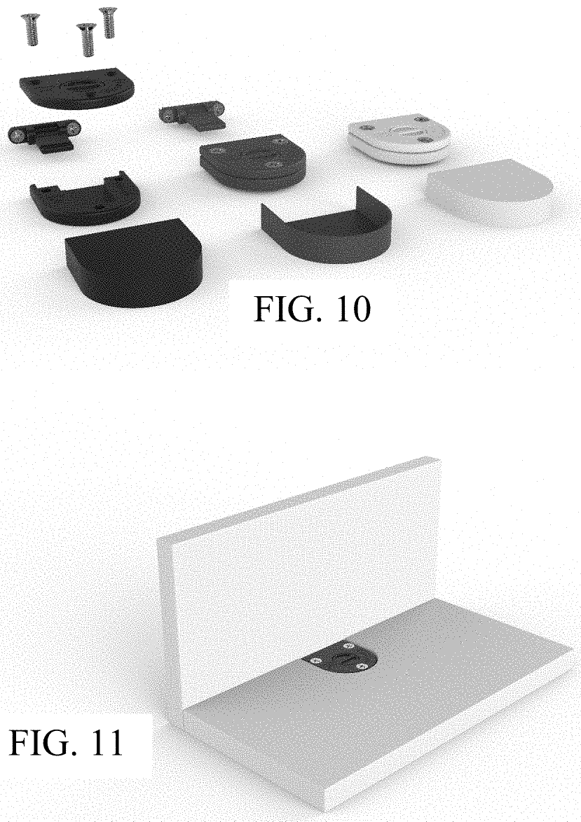

FIG. 10 is another view of some of the components of the system 100. FIG. 11 through FIG. 13 provides several views of the system 100 in completed form. The cover 120 covers the completed device and conceals the dial magnet assembly 108 and the base frame mount screws 118a-c.

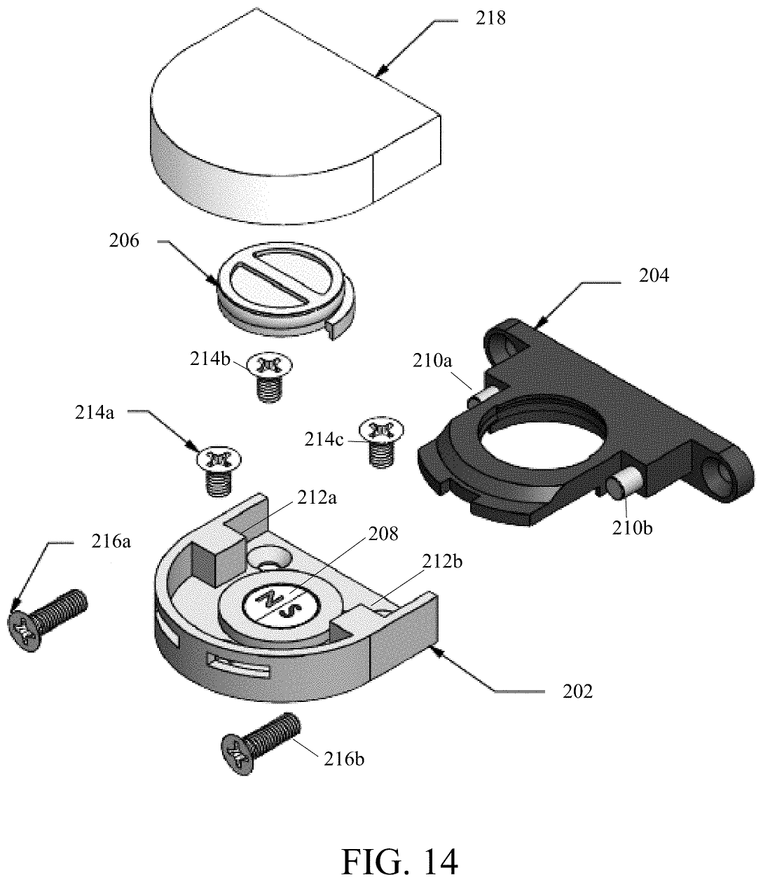

FIG. 14 is a diagram of a system of a flat panel fastener device using magnesive reverse polarity according to an embodiment of the present disclosure. FIG. 14 depicts components of a system 200 of the Glide It™ as the configuration may be referred to commercially. Components and interactions of the Glide It™ are illustrated in FIG. 14 through FIG. 21.

The system 200 resembles the system 100 in which panels are joined perpendicularly by a first component containing a first magnet receiving placement into a second component containing a second magnet. When the first magnet is then turned via a dialing action, polarity changes, the first and second magnets attract, and the panels to which the components are attached are bound.

While similar to the system 100, the system 200 differs from the system 100 in several respects. First, the system 200 does not have a top frame. The magnet that is in the top frame in the system 100 is instead located in the system 200 in what equates to the base frame here in the system 200. Second, in the system 200, dowel pins are attached to what equates to the slider mount assembly. The dowel pins insert into the body of the base frame in the system 200. This structure provides stability. Dowel pins are not provided by the system 100.

The system 200 comprises a base frame magnet assembly 202, a slider dowel pin assembly 204, a dial magnet assembly 206, and an embedded magnet 208. The system 200 also comprises dowel pins 210a-b, dowel pin insert holes 212a-b, base mount screws 214a-c, slider mount screws 216a-b, and a cover 218.

The base frame magnet assembly 202 attaches to a first panel in a recessed manner similar to the structure of the system 100. The base mount screws 214a-c are used to affix the base frame magnet assembly 202 to the floor surface of the indentation that is created in a similar manner to the process associated with the system 100 and illustrated at least in FIG. 2 and FIG. 3. While a top frame is not a component of the system 200, the upper plane of the base frame magnet assembly 202 is still flush with the surface of the first panel.

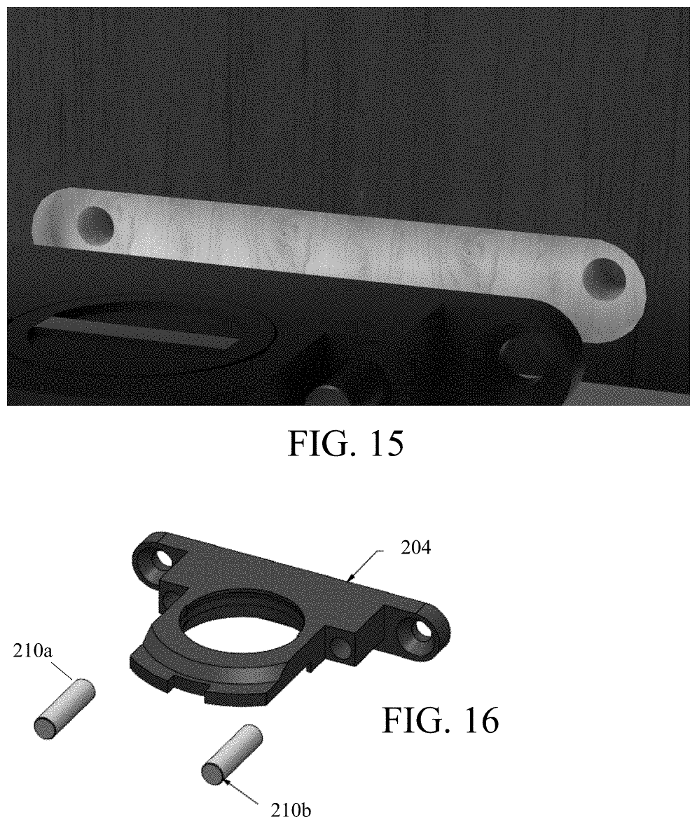

The slider dowel pin assembly 204 attaches to a second panel proximate an edge of the second panel. The slider dowel pin assembly 204 is partially recessed into the second panel unlike the structure of the system 100. This is illustrated in FIG. 15. The slider mount screws 216a-b are used to affix the slider dowel pin assembly 204 into the recessed area of the second panel. The dial magnet assembly 206 sets into a hole in the middle of the slider dowel pin assembly 204 and may be manually rotated.

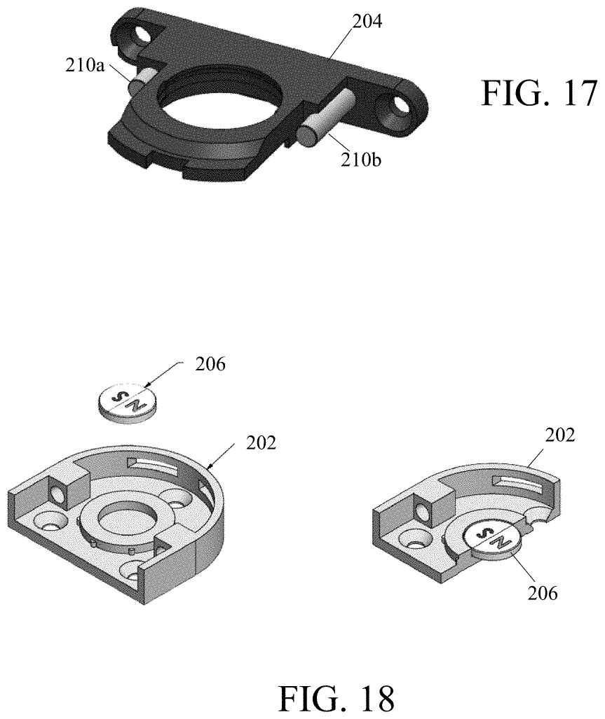

To join the first panel to the second panel, the slider dowel pin assembly 204 is inserted into the base frame magnet assembly 202 although there is not a cavity as in the case of the system 100. Instead, the dowel pins 210a-b on the slider dowel pin assembly 204 are inserted into the dowel pin insert holes 212a-b in the base frame magnet assembly 202. FIG. 16 and FIG. 17 illustrate the dowel pins 210a-b on the slider dowel pin assembly 204. FIG. 18 illustrates the base frame magnet assembly 202 and the dial magnet assembly 206.

The dial magnet assembly 206 is then rotated. The changing of polarity based on the rotation causes the dial magnet assembly 206 to be attracted to the embedded magnet 208 with a resultant binding of the slider dowel pin assembly 204 to the base frame magnet assembly 202 and further resultant binding of the first and second frames. Rotation of the dial magnet assembly 206 in the opposite direction causes the magnets to repel with the first and second frames decoupling as a result.

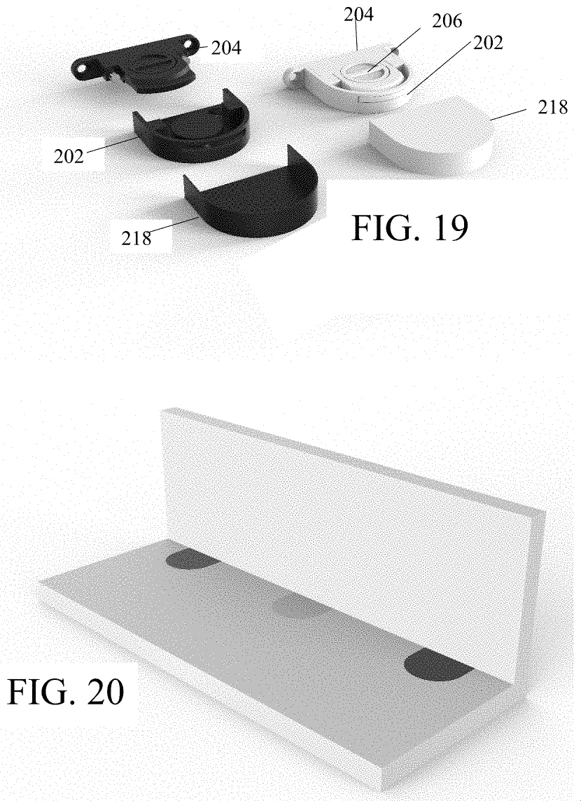

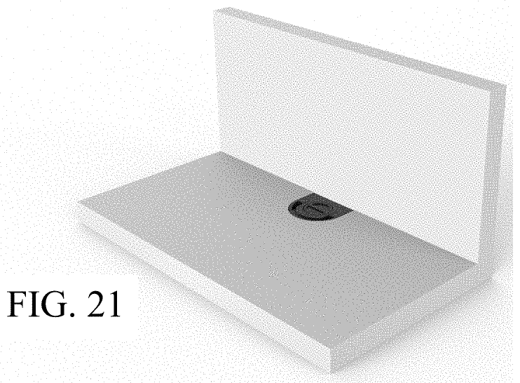

FIG. 19 is another view of the components of the system 200. FIG. 20 and FIG. 21 illustrate the system 200 in completed form and in use.

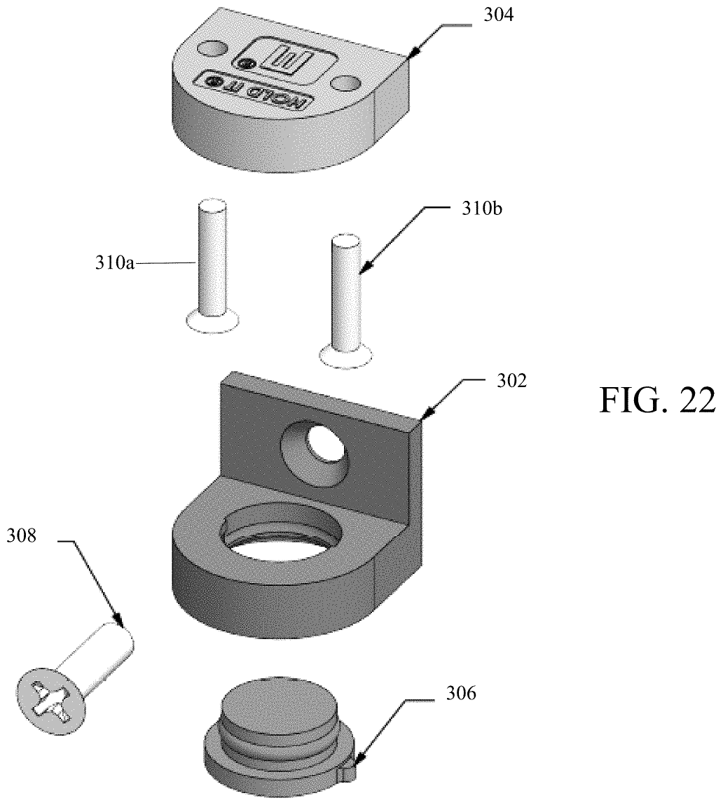

FIG. 22 is a diagram of a system of a flat panel fastener device using magnesive reverse polarity according to an embodiment of the present disclosure. FIG. 22 depicts components of a system 300 of the Hold It as the configuration may be referred to commercially.

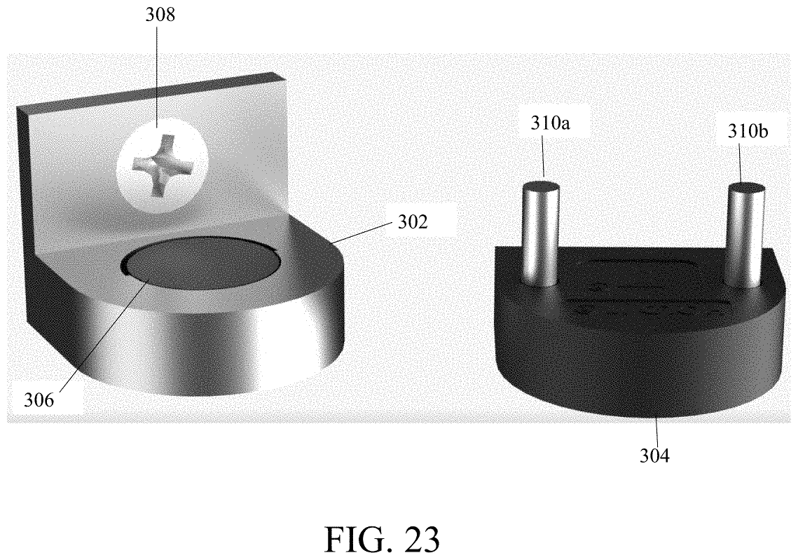

The system 300 comprises a frame 302, a holder magnet assembly 304, and a dial magnet assembly 306 contained within the frame 302. The system 300 also comprises one frame mount screw 308 and two holder mount screws 310a-b. While not visible in FIG. 22, the holder magnet assembly 304 contains an embedded magnet 312. Further, while not shown in FIG. 22 but shown in other figures, the dial magnet assembly 306 contains a dial magnet 314. FIG. 23 depicts some of the components in greater detail.

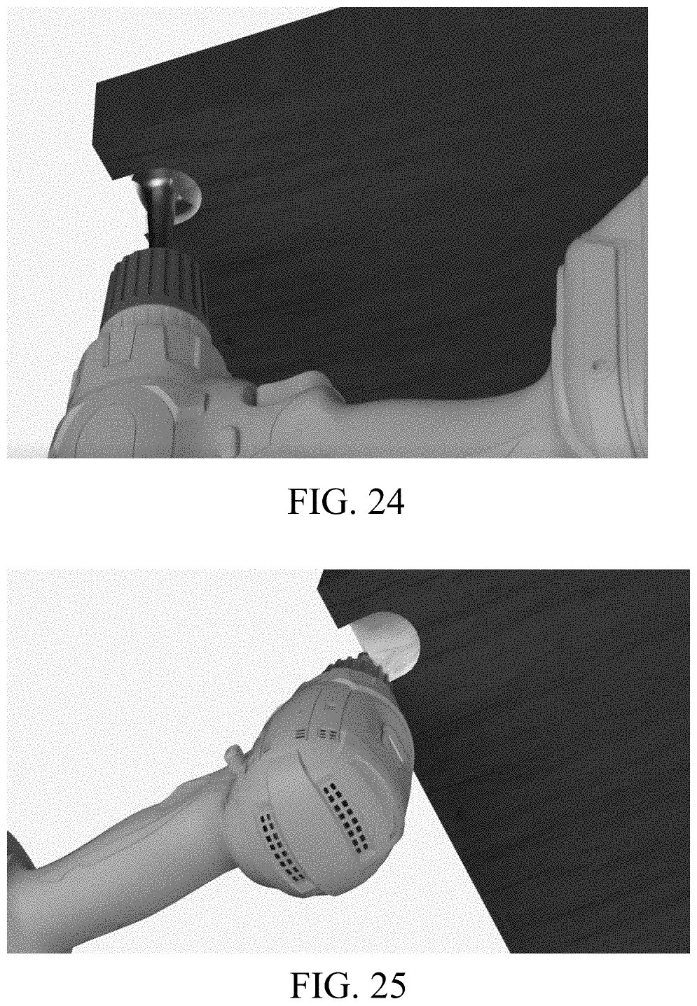

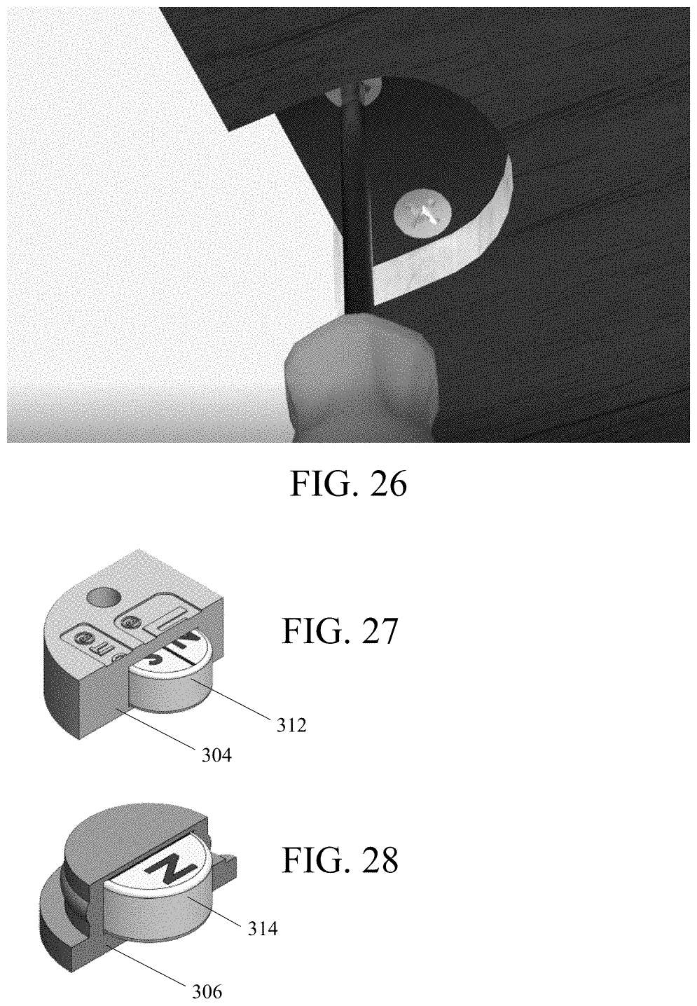

The holder magnet assembly 304 is placed in a recessed fashion in an underside surface of a shelf that is to be installed in a bookshelf or cupboard. The holder magnet assembly 304 is semicircular in shape with a straight edge that is positioned along the edge of the shelf of panel, usually at an end of the shelf or panel Two holder mount screws 310a-b attach the holder magnet assembly 304 to the horizonal shelf as the holder magnet assembly 304 is effectively upside down. FIG. 24 through FIG. 26 illustrate how a recessed area in the panel is drilled and bored by standard drilling tools with specialized drilling bits. As is shown in FIG. 25, a portion of the front edge of the panel on which the holder magnet assembly 304 is installed is cut away to allow the components provided herein the fit together properly.

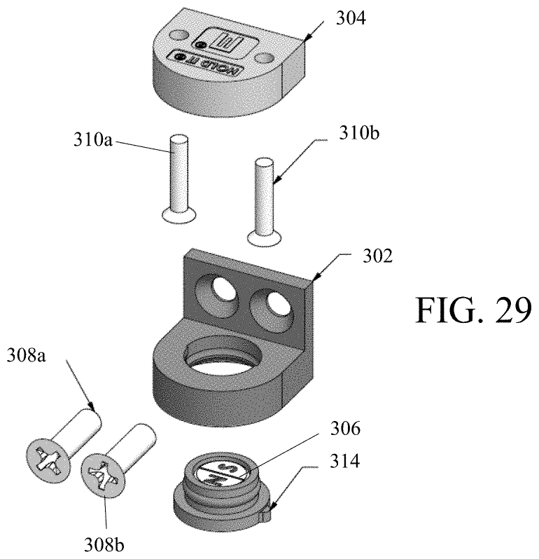

The frame 302 is attached to an interior surface of the bookshelf or cupboard wall. Either one frame mount screw 308 or two frame mount screws 308a-b (shown in FIG. 29 and FIG. 30) may be used for such attachment.

Once the horizontal shelf panel has received installation of the holder magnet assembly 304 and the frame 302 is installed on the vertical sidewall of the bookshelf or cupboard, the horizontal shelf panel with the holder magnet assembly 304 installed and facing downward may be laid atop the frame 302. The dial magnet assembly 306 in the frame 302 is then turned, changing polarity, and attracting to the embedded magnet 312 in the holder magnet assembly 304. Turning the dial magnet assembly 306 in the opposite direction results in the dial magnet assembly 306 land the embedded magnet 312 repelling instead of attracting such that the panels are no longer joined.

FIG. 27 depicts the holder magnet assembly 304 with embedded magnet 312. FIG. 28 depicts the dial magnet assembly 306 with dial magnet 314.

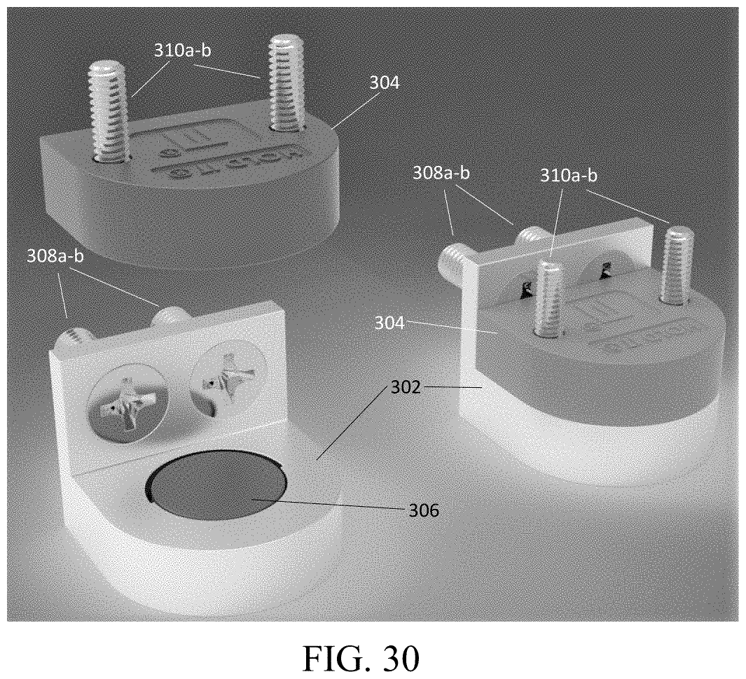

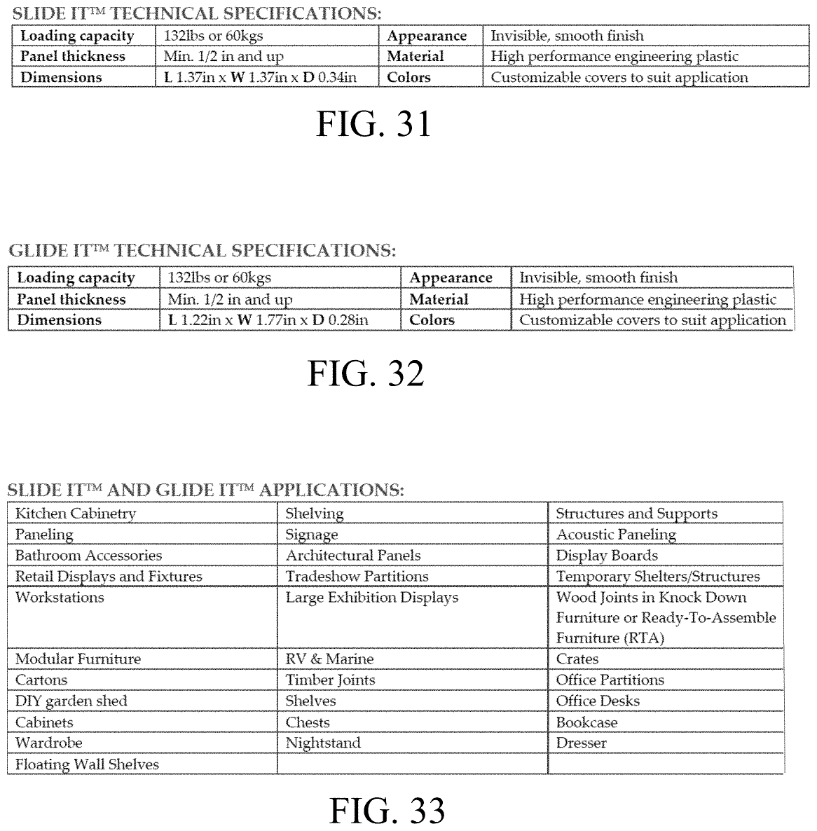

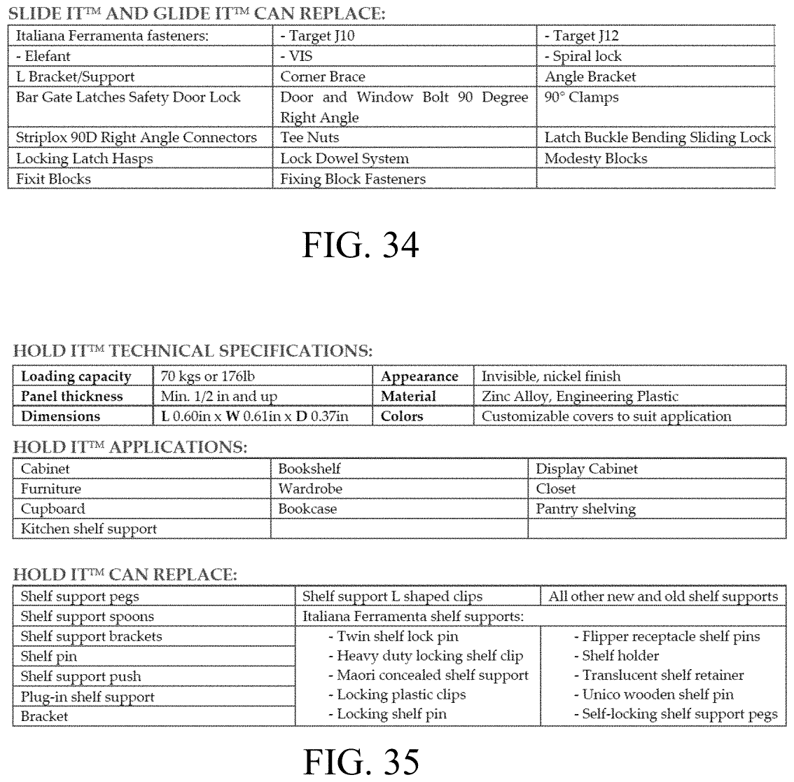

FIG. 29 depicts the components of the system 300 and matches the components in FIG. 22 with the exception that the frame 302 has two holes instead of one to accommodate two frame mount screws 308a-b. This configuration is also shown in FIG. 30 which provides another view of the components of the Hold It. FIG. 31 through FIG. 35 are tables providing information about the systems provided herein according to embodiments of the present disclosure.

Magnets for all of Slide It™, Glide It, and Hold It™ may be exposed or fully concealed through an overmold plastic operation. In embodiments, the magnet held by the dial magnet assembly is not completely encased into or enveloped by the dial magnet assembly.

In an embodiment, a system for fastening panels in a perpendicular manner is provided. The system comprises a semicircular base frame attached in a recessed manner into an edge area of a first panel, a similarly shaped semicircular top frame fastened atop the base frame, and a dial magnet assembly resident in the top frame. The system also comprises a slider mount assembly with an embedded magnet and attached proximate an edge of a second panel that receives insertion into a cavity created by the fastening of the top frame to the base frame. The slider mount assembly also receives attraction to the top frame based on a turning action of the dial magnet assembly in a first direction and binds to the fastened top frame and base frame based on the received attraction. The binding of the slider mount assembly to the fastened frames binds the second panel to the first panel in a perpendicular manner.

The turning action of the dial magnet assembly changes polarity and results in attraction to the embedded magnet in the slider mount assembly. When the top frame is fastened atop the base frame, an upper surface of the top frame is flush with a surface of the first panel. The dial magnet assembly is manually accessible at a top area of the top frame.

To release the slider mount assembly from the attraction, the dial magnet assembly is turned in a second direction, the second direction opposite of the first direction. Release of the slider mount assembly results in decoupling of the first panel and the second panel.

The slider mount assembly further comprises a bracket attached to the second panel and a pin. The bracket and pin promote the slider mount assembly to swivel in upward and downward directions thus providing flexibility during insertion of the slider mount assembly into the cavity.

In another embodiment, a system for perpendicularly joining panels is provided. The system comprises a semicircular base frame magnet assembly attached in a recessed manner at a first edge are of a first panel, the assembly containing an embedded magnet. The system also comprises a slider dowel pin assembly attached at a second edge of a second panel, the dowel pin assembly protruding from the second panel at a right angle. The system also comprises a dial magnet assembly held within the slider dowel pin assembly that receives a first turning action in a first direction after the slider dowel pin assembly is inserted into base frame magnet assembly. Based on the received first turning action, the dial magnet assembly also attracts to the embedded magnet, the attraction binding the slider dowel pin assembly to the base frame magnet assembly.

Based on receiving a second turning action in a second direction, the second direction opposite the first direction, the dial magnet assembly repels the embedded magnet, the repelling causing unbinding of the slider dowel pin assembly from the base frame magnet assembly. The slider dowel pin assembly further contains dowel pins that insert into dowel pin holes in the base frame magnet assembly.

The insertion of the dowel pins into the dowel pin holes in the base frame magnet assembly is directed to providing further stability to the system. The turning actions change polarity within the system.

In yet another embodiment, a system for attaching horizontal panel to vertical panels is provided. The system comprises a semicircular holder magnet assembly embedded into a downward-facing surface of a horizontal panel, an outer surface of the assembly flush with the downward-facing surface of the panel. The system also comprises a frame attached to a vertical panel that receives placement of the holder magnet assembly on an upward facing surface of the frame. The frame also receives a first turning action in a first direction of a horizontal coin-like dial magnet assembly embedded in the frame. The frame also receives, based on the action, binding to the holder magnet assembly.

The binding of the frame to the holder magnet assembly is received by the frame based on attraction of the dial magnet assembly to a holder magnet embedded in the holder magnet assembly. The first turning action changes polarity, thus resulting in the attraction.

The vertical panel is a side panel of one of a bookshelf and a cupboard. The frame is attached to an interior-facing surface of the vertical panel.

A second turning action of the dial magnet assembly in a second direction further changes polarity and causes the dial magnet assembly and the holder magnet to repel. The repelling action results in the horizontal panel and the vertical panel becoming unbound.

What is claimed is:

1. A system for fastening panels in a perpendicular manner, comprising:
a semicircular base frame attached in a recessed manner into an edge area of a first panel;
a similarly shaped semicircular top frame fastened atop the base frame;
a dial magnet assembly resident in the top frame; and
a slider mount assembly with an embedded magnet and attached proximate an edge of a second panel that:
receives insertion into a cavity created by the fastening of the top frame to the base frame,
receives attraction to the top frame based on a turning action of the dial magnet assembly in a first direction, and
binds to the fastened top frame and base frame based on the received attraction.

2. The system of claim 1, wherein the binding of the slider mount assembly to the fastened frames binds the second panel to the first panel in a perpendicular manner.

3. The system of claim 1, wherein the turning action of the dial magnet assembly changes polarity and results in attraction to the embedded magnet in the slider mount assembly.

4. The system of claim 1, wherein when the top frame is fastened atop the base frame, an upper surface of the top frame is flush with a surface of the first panel.

5. The system of claim 1, wherein the dial magnet assembly is manually accessible at a top area of the top frame.

6. The system of claim 1, wherein to release the slider mount assembly from the attraction, the dial magnet assembly is turned in a second direction, the second direction opposite of the first direction.

7. The system of claim 6, wherein release of the slider mount assembly results in decoupling of the first panel and the second panel.

8. The system of claim 1, wherein the slider mount assembly further comprises a bracket attached to the second panel and a pin which promote the slider mount assembly to swivel in upward and downward directions thus providing flexibility during insertion of the slider mount assembly into the cavity.

9. A system for perpendicularly joining panels, comprising:
a semicircular base frame magnet assembly attached in a recessed manner at a first edge are of a first panel, the assembly containing an embedded magnet;
a slider dowel pin assembly attached at a second edge of a second panel, the dowel pin assembly protruding from the second panel at a right angle; and
a dial magnet assembly held within the slider dowel pin assembly that:
receives a first turning action in a first direction after the slider dowel pin assembly is inserted into base frame magnet assembly, and
based on the received first turning action, attracts to the embedded magnet, the attraction binding the slider dowel pin assembly to the base frame magnet assembly.

10. The system of claim 9, wherein based on receiving a second turning action in a second direction, the second direction opposite the first direction, the dial magnet assembly repels the embedded magnet, the repelling causing unbinding of the slider dowel pin assembly from the base frame magnet assembly.

11. The system of claim 9, wherein the slider dowel pin assembly further contains dowel pins that insert into dowel pin holes in the base frame magnet assembly.

12. The system of claim 11, wherein the insertion of the dowel pins into the dowel pin holes in the base frame magnet assembly is directed to providing further stability to the system.

13. The system of claim 9, wherein the turning actions change polarity within the system.

14. A system for attaching horizontal panel to vertical panels, comprising:
a semicircular holder magnet assembly embedded into a downward-facing surface of a horizontal panel, an outer surface of the assembly flush with the downward-facing surface of the panel; and
a frame attached to a vertical panel that:
receives placement of the holder magnet assembly on an upward facing surface of the frame,
receives a first turning action in a first direction of a horizontal coin-like dial magnet assembly embedded in the frame, and
receives, based on the action, binding to the holder magnet assembly.

15. The system of claim 14, wherein the binding of the frame to the holder magnet assembly is received by the frame based on attraction of the dial magnet assembly to a holder magnet embedded in the holder magnet assembly.

16. The system of claim 14, wherein the first turning action changes polarity, thus resulting in the attraction.

17. The system of claim 14, wherein the vertical panel is a side panel of one of a bookshelf and a cupboard.

18. The system of claim 14, wherein the frame is attached to an interior-facing surface of the vertical panel.

19. The system of claim 14, wherein a second turning action of the dial magnet assembly in a second direction further changes polarity and causes the dial magnet assembly and the holder magnet to repel.

20. The system of claim 19, wherein the repelling action results in the horizontal panel and the vertical panel becoming unbound.
